(19) United States
(12) Patent Application Publication
(10) Pub. No.: US 2017/0085781 A1
(43) Pub. Date: Mar. 23, 2017

(54) METHOD AND APPARATUS FOR CONTROLLING POSITIONING OF CAMERA DEVICE

(71) Applicant: Xiaomi Inc., Beijing (CN)

(72) Inventors: Qiang FU, Beijing (CN); Sihan HAO, Beijing (CN); Enxing HOU, Beijing (CN)

(73) Assignee: Xiaomi Inc.

(21) Appl. No.: 15/264,733

(22) Filed: Sep. 14, 2016

(30) Foreign Application Priority Data
Sep. 17, 2015 (CN) 201510595608.8

(51) Int. Cl. H04N 5/232; H04N 7/18

(52) U.S. Cl. CPC H04N 5/23216; H04N 7/183

(57) ABSTRACT

A method and an apparatus for controlling a positioning of a camera device. The method includes: controlling a motor connected with the camera device to move in a horizontal direction, determining a horizontal center position according to a movement of the motor between two limit positions in the horizontal direction, and moving the camera device to the horizontal center position; and controlling the motor connected with the camera device to move in a vertical direction, determining a vertical center position according to a movement of the motor between two limit positions in the vertical direction, and moving the camera device to the vertical center position.

### CROSS-REFERENCE TO RELATED APPLICATIONS

This application is based upon and claims priority to Chinese Patent Application No. 201510595608.8, filed Sep. 17, 2015, the entire contents of which are incorporated herein by reference.

### TECHNICAL FIELD

The present disclosure generally relates to a smart home field, and more particularly, to a method and an apparatus for controlling a positioning of a camera device.

### BACKGROUND

There are various camera devices on current market for camera shooting and monitoring. A security camera, as one kind of camera device, has a narrow monitoring view field due to its own structure. In the related art, the security camera is provided with a rotatable pan tilt, such that a user can adjust a region monitored by the security camera by controlling a motor in the pan tilt, thus expanding the region monitored by the security camera largely.

### SUMMARY

According to a first aspect of embodiments of the present disclosure, there is provided a method for controlling a positioning of a camera device, including: controlling a motor connected with the camera device to move in a horizontal direction, determining a horizontal center position according to a movement of the motor between two limit positions in the horizontal direction, and moving the camera device to the horizontal center position; and controlling the motor connected with the camera device to move in a vertical direction, determining a vertical center position according to a movement of the motor between two limit positions in the vertical direction, and moving the camera device to the vertical center position.

According to a second aspect of embodiments of the present disclosure, there is provided an apparatus for controlling a positioning of a camera device, including: a processor; and a memory for storing instructions executable by the processor. The processor is configured to, when executing the instructions stored in the memory: control a motor connected with the camera device to move in a horizontal direction, determine a horizontal center position according to a movement of the motor between two limit positions in the horizontal direction, and move the camera device to the horizontal center position; and control the motor connected with the camera device to move in a vertical direction, determine a vertical center position according to a movement of the motor between two limit positions in the vertical direction, and move the camera device to the vertical center position.

According to a third aspect of embodiments of the present disclosure, there is provided a camera device, including: a pan tilt provided with a motor for driving the camera device to move; and a micro-processor, configured to control the motor to move in a horizontal direction, to determine a horizontal center position according to a movement of the motor between two limit positions in the horizontal direction, and to move the camera device to the horizontal center position; and to control the motor to move in a vertical direction, to determine a vertical center position according to a movement of the motor between two limit positions in the vertical direction, and to move the camera device to the vertical center position.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for controlling a positioning of a camera device according to an exemplary embodiment.

FIG. 2 is a flow chart of a method for controlling a positioning of a camera device according to an exemplary embodiment.

FIG. 3 is a flow chart of a method for controlling a positioning of a camera device according to an exemplary embodiment.

FIG. 4 is a block diagram of an apparatus for controlling a positioning of a camera device according to an exemplary embodiment.

FIG. 5 is a block diagram of an apparatus for controlling a positioning of a camera device according to an exemplary embodiment.

FIG. 6 is a block diagram of a camera device according to an exemplary embodiment.

FIG. 7 is a block diagram of a terminal device according to an exemplary embodiment.

FIG. 8 is a block diagram of a device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items.

It should be understood that, although terms such as “first,” “second”, and “third” are used herein for describing various information, these information should not be limited by these terms. These terms are only used for distinguishing information of the same type. For example, first information may also be called second information, and similarly, the second information may also be called the first information, without departing from the scope of the present disclosure. As used herein, the term “if” may be construed to mean “when” or “upon” or “in response to determining” depending on the context.

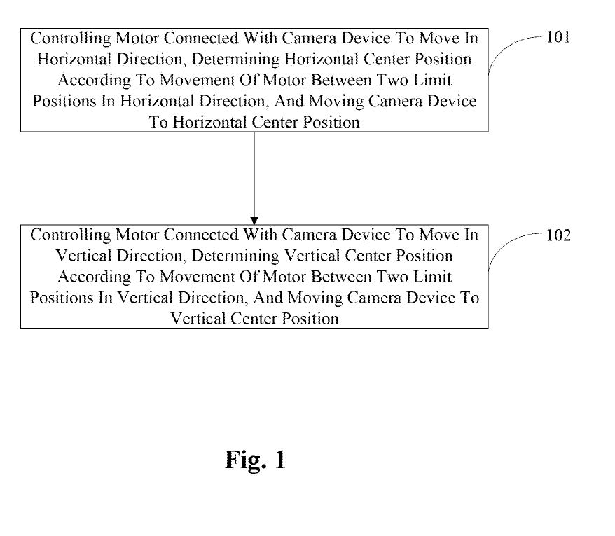

FIG. 1 is a flow chart of a method for controlling a positioning of a camera device according to an exemplary embodiment. The method can be used in a camera device, and includes the following steps.

In step 101, a motor connected with the camera device is controlled to move in a horizontal direction, a horizontal center position is determined according to a movement of the motor between two limit positions in the horizontal direction, and the camera device is moved to the horizontal center position.

In this step, the motor connected with the camera device is controlled to move in one of a horizontal-left direction and a horizontal-right direction. A rotation number of the motor is recorded when the motor is moved to the limit position in the one of the horizontal-left direction and the horizontal-right direction. The rotation number of the motor refers to a number of rotations of the motor, and is used to represent a current coordinate position of the motor. The motor is then moved in the other of the horizontal-left direction and the horizontal-right direction. An accumulative number of rotation turns of the motor between the two limit positions in the horizontal direction is recorded when the motor is moved to the limit position in the other of the horizontal-left direction and the horizontal-right direction. For example, if the rotation number of the motor when the motor is moved to the limit position in the horizontal-left direction is R1, and the rotation number of the motor when the motor is moved to the limit position in the horizontal-right direction is R2, then the accumulative number of rotation turns of the motor between the two limit positions in the horizontal direction is calculated as |R2−R1|. Afterwards, the motor is moved in the one of the horizontal-left direction and the horizontal-right direction again by half of the accumulative number of rotation turns of the motor, so as to move the camera device to the horizontal center position.

In step 102, the motor connected with the camera device is controlled to move in a vertical direction, a vertical center position is determined according to a movement of the motor between two limit positions in the vertical direction, and the camera device is moved to the vertical center position.

In this step, the motor connected with the camera device is controlled to move in one of a vertical-up direction and a vertical-down direction. A rotation number of the motor, which represents the current position of the motor, is recorded when the motor is moved to the limit position in the one of the vertical-up direction and the vertical-down direction. The motor is then moved in the other of the vertical-up direction and the vertical-down direction. An accumulative number of rotation turns of the motor between the two limit positions in the vertical direction is recorded when the motor is moved to the limit position in the other of the vertical-up direction and the vertical-down direction. Afterwards, the motor is moved in the one of the vertical-up direction and the vertical-down direction again by half of the accumulative rotation turns of the motor, so as to move the camera device to the vertical center position.

It should be noted that, the sequence of the above steps 101 and 102 is not limited. The camera device can be first moved to the horizontal center position or the vertical center position by moving the motor to the horizontal center position or the vertical center position, as long as the camera device is moved to a center position.

In the present embodiment, by controlling the motor connected with the camera device to move in the horizontal direction and the vertical direction respectively, the horizontal center position can be determined according to the movement of the motor between the two limit positions in the horizontal direction, and the vertical center position can be determined according to the movement of the motor between the two limit positions in the vertical direction, and finally the camera device can be moved to the horizontal center position and the vertical center position. In this manner, it is possible to control the camera device to be accurately positioned to a center position and thus to ensure the accuracy of the monitoring of the camera device.

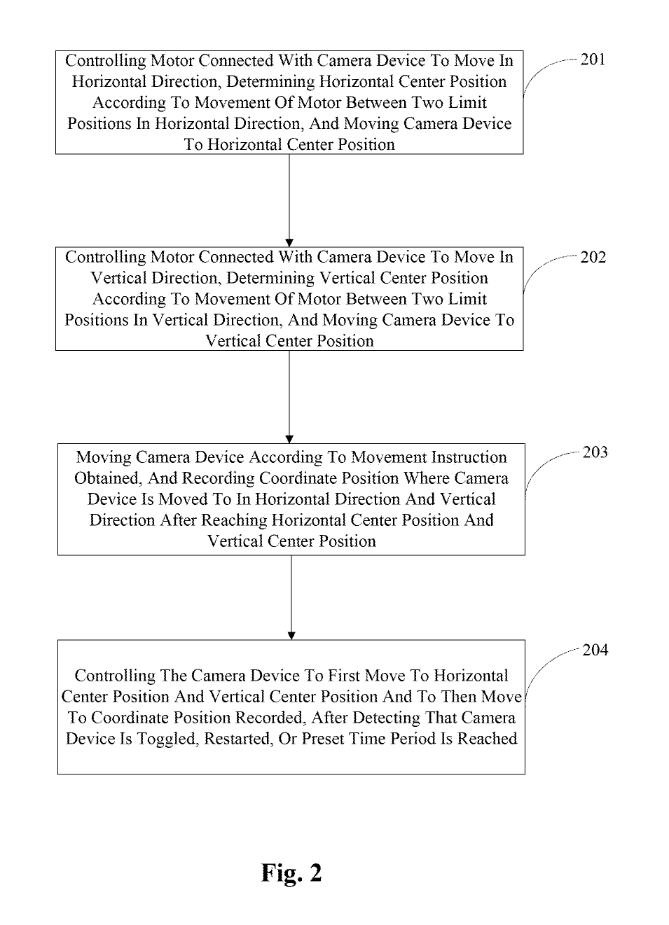

FIG. 2 is a flow chart of a method for controlling a positioning of a camera device according to an exemplary embodiment. The method can be used in a camera device, and includes the following steps.

In step 201, a motor connected with the camera device is controlled to move in a horizontal direction, a horizontal center position is determined according to the movement of the motor between two limit positions in the horizontal direction, and the camera device is moved to the horizontal center position, similar to the description above in connection with step 101 (FIG. 1).

In step 202, the motor connected with the camera device is controlled to move in a vertical direction, a vertical center position is determined according to the movement of the motor between two limit positions in the vertical direction, and the camera device is moved to the vertical center position, similar to the description above in connection with step 102 (FIG. 2).

In step 203, the camera device is moved by moving the motor according to a movement instruction obtained, and a coordinate position where the camera device is moved to in the horizontal direction and the vertical direction after reaching the horizontal center position and the vertical center position is recorded.

In this step, a movement instruction is obtained from a mobile terminal or a remote controller. The movement instruction includes a target position to be moved to. The camera device is moved to the target position from the horizontal center position and the vertical center position according to the target position. The coordinate position where the camera device is moved to in the horizontal direction and the vertical direction is recorded by recording a rotation number and a rotation direction of the motor in each of the horizontal direction and the vertical direction.

Obtaining a movement instruction from a mobile terminal or a remote controller includes: obtaining a movement instruction transmitted from the mobile terminal or the remote controller via WiFi, Bluetooth, or infrared connection.

In step 204, after it is detected that the camera device is toggled, restarted, or a preset time period is reached, the camera device is controlled to first move to the horizontal center position and the vertical center position and to then move to the recorded coordinate position where the camera device has been moved to in the horizontal direction and the vertical direction.

The preset time period in this step can be set by day or hour, e.g., every several days or every several hours.

In the present embodiment, after the motor controls the camera device to reach the horizontal center position and the vertical center position, the camera device can be moved to the target position according to the movement instruction obtained, and the coordinate position where the camera device is moved to in the horizontal direction and the vertical direction is recorded. After it is detected that the camera device is toggled or restarted or the preset time period is reached, it is determined that an automatic reset process is triggered, such that the camera device is controlled to first move to the horizontal center position and the vertical center position and to then move to the recorded coordinate position where the camera device has been moved to in the horizontal direction and the vertical direction, thus realizing accurate positioning of the camera device in use.

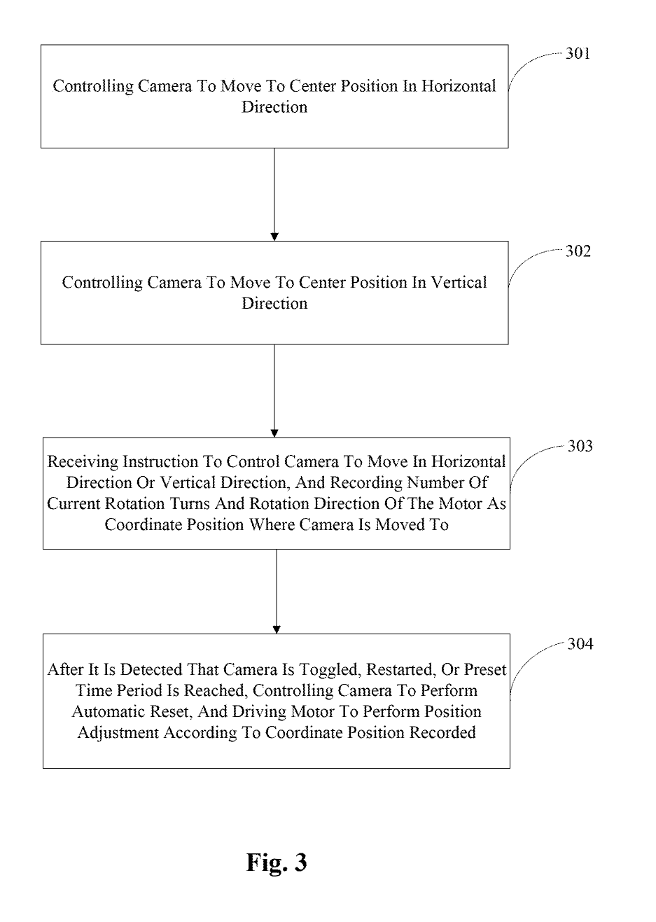

FIG. 3 is a flow chart of a method for controlling a positioning of a camera device according to an exemplary embodiment.

The method can be used in a camera device. The camera device can be a smart camera provided with a pan tilt, whose monitoring position can be adjusted by an application program (“APP”) in a mobile phone. The pan tilt is provided with a motor for controlling a horizontal movement and a motor for controlling a vertical movement.

The method includes the following steps.

In step 301, a camera is controlled to move to a center position in a horizontal direction.

When the camera is started, a MCU (micro controller unit) in the camera controls the motor for controlling the horizontal movement to first move leftwards in the horizontal direction. When the motor is moved to a left limit position, a limit switch of the pan tilt is triggered to give the MCU a notification that the motor cannot be moved leftwards any more. Upon receiving the notification, the MCU records a coordinate position of the motor represented by a rotation number of the motor and controls the motor to move rightwards. After the motor is moved to a right limit position and the limit switch is triggered, the MCU records an accumulative number of rotation turns N (x) of the motor. According to the accumulative number of rotation turns N (x) of the motor, it can be known that a position which is moved to after the motor is rotated by N (x)/2 rotation turns is the center position in the horizontal direction. Thus, the MCU controls the motor to move leftwards in the horizontal direction from the right limit position by N (x)/2 rotation turns and then to stop moving in the horizontal direction. At this time, the camera is in the center position in the horizontal direction.

It should be noted that, in the above description, controlling the motor to first move leftwards in the horizontal direction is taken as an example. However, the motor can also be first moved rightwards in the horizontal direction, and the principles thereof are similar.

In step 302, the camera is controlled to move to a center position in a vertical direction.

In this step, the MCU positions the camera to move to the center position in the vertical direction according to a method similar to that in step 301. This step includes the following steps.

The MCU in the camera controls the motor for controlling the vertical movement to first move upwards. When the motor is moved to an upper limit position, the limit switch of the pan tilt is triggered to give the MCU a notification that the motor cannot be moved upwards any more. Upon receiving the notification, the MCU records a rotation number of the motor and controls the motor to move downwards. After the motor is moved to a lower limit position and the limit switch is triggered, the MCU records an accumulative number of rotation turns N (x) of the motor. According to the accumulative rotation turns N (x) of the motor, it can be known that a position which is moved to after the motor is rotated by N (x)/2 rotation turns is the center position in the vertical direction. Thus, the MCU controls the motor to move upwards in the vertical direction from the lower limit position by N (x)/2 rotation turns and then to stop moving in the vertical direction. At this time, the camera is in the center position in the vertical direction.

It should be noted that, in the above description, controlling the motor to first move upwards in the vertical direction is taken as an example. However, the motor can also be first moved downwards in the vertical direction, and the principles thereof are similar.

It should also be noted that, in the above steps 301 and 302, first moving the camera to the center position in the horizontal direction and then moving the camera to the center position in the vertical direction are taken as an example. However, the present disclosure is not limited to this. The camera can be first moved to the center position in the vertical direction, and then moved to the center position in the horizontal direction, as long as the camera may be moved to a center position.

In step 303, an instruction is received for controlling the camera to move in the horizontal direction or the vertical direction, and a current rotation number and a rotation direction of the motor are recorded as a coordinate position where the camera is moved to.

In this step, the camera can receive an instruction which is sent by a user from a mobile terminal such as a mobile phone or other remote controllers for moving. The camera is provided with a chip or module supporting WiFi, Bluetooth, or infrared connection. The mobile terminal or the remote controller can establish a communication with the camera via WiFi, Bluetooth, or infrared connection, and transmit a movement instruction.

The MCU can record current rotation numbers and rotation directions of the motor for controlling the horizontal movement and the motor for controlling the vertical movement when controlling the camera to move in the horizontal direction or the vertical direction according to the instruction received.

For example, a user may set that the camera moves from point A to point B via an application program of a mobile phone. When the MCU obtains an instruction transmitted from the application program of the mobile phone, the MCU controls the camera to move from point A to point B via the motor, records current rotation numbers and rotation directions of the motor for controlling the horizontal movement and the motor for controlling the vertical movement, and transmits the recorded data to the application program of the mobile phone. The recorded data can be further transmitted to a server, and the server can set a storage area for storing monitoring videos shot by the camera, and sends a storage address to the mobile phone, such that it is possible to view the monitoring videos according to the storage address on the mobile phone.

In the above step, the recorded rotation numbers and the rotation direction of the motor are used as coordinates. For example, a coordinate at the center position is 0, a coordinate where the motor is rotated leftwards or downwards is negative, and a coordinate where the motor is rotated rightwards or upwards is positive.

In step 304, after it is detected that the camera is toggled, restarted, or a preset time period is reached, the camera is controlled to perform automatic reset, and the motor is driven to perform position adjustment according to the recorded coordinate position.

In this step, after the user toggles the camera by hand, the camera is restarted, or the preset time period is reached, the camera is triggered to perform a reset process.

The MCU controls the camera to first perform an automatic reset process in steps 301 and 302, and then drives the motor to perform position adjustment according to the coordinate position recorded in step 303. Concerning the automatic reset process, reference is made to the description of steps 301 and 302, which is not elaborated herein.

When the camera is in user during a monitoring process, if the camera is toggled, monitoring position and region will be changed, which does not satisfy a monitoring requirement originally set. Therefore, the camera is triggered to perform a reset process in order to return to original monitoring position and state. In addition, if the camera is restarted for various reasons, the camera needs to return to original monitoring position and state. Therefore, in this case, the camera is also triggered to perform the reset process. In addition, it is also possible to perform a reset process periodically, e.g., to perform the reset process every several days, which is not limited in the present disclosure.

The present disclosure provides a processing manner of automatically positioning the camera to the center position when the camera is started and a processing manner of automatic reset calibration when the camera is in use. When a smart camera is used, wrong angle judgment of the camera occurs because the user rotates the camera. For example, a loop monitoring by a camera from point A to point B is previously set, and after the camera is rotated by a user, the monitoring region of the camera is not accurate any more. In this case, this problem can be solved by automatic calibration of the camera according to the embodiments of the present disclosure. Once it is detected that the user toggles the camera by hand, the reset process is triggered, and the camera is first automatically positioned to the center position and then moved to the recorded position so as to realize accurate positioning of the camera, thus enhancing the accuracy of the monitoring of the camera and the accuracy of a monitoring screen.

Correspondingly to the method according to the above embodiments, the present disclosure further provides embodiments of an apparatus for controlling a positioning of a camera device and a corresponding terminal.

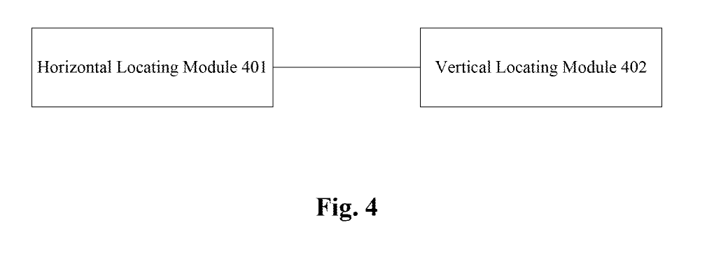

FIG. 4 is a block diagram of an apparatus for controlling a positioning of a camera device according to an exemplary embodiment.

As shown in FIG. 4, the apparatus for controlling the positioning of the camera device includes a horizontal locating module 401 and a vertical locating module 402.

The horizontal locating module 401 is configured to control a motor connected with the camera device to move in a horizontal direction, to determine a horizontal center position according to a movement of the motor between two limit positions in the horizontal direction, and to move the camera device to the horizontal center position.

The vertical locating module 402 is configured to control the motor connected with the camera device to move in a vertical direction, to determine a vertical center position according to a movement of the motor two limit positions in the vertical direction, and to move the camera device to the vertical center position.

In the present embodiment, by controlling the motor connected with the camera device to move in the horizontal direction and the vertical direction respectively, the horizontal center position can be determined according to the movement of the motor between the two limit positions in the horizontal direction and the vertical center position can be determined according to the movement of the motor between the two limit positions in the vertical direction, and finally the camera device can be moved to the horizontal center position and the vertical center position. In this manner, it is possible to control the camera device to be accurately positioned to a center position and thus to ensure the accuracy of the monitoring of the camera device.

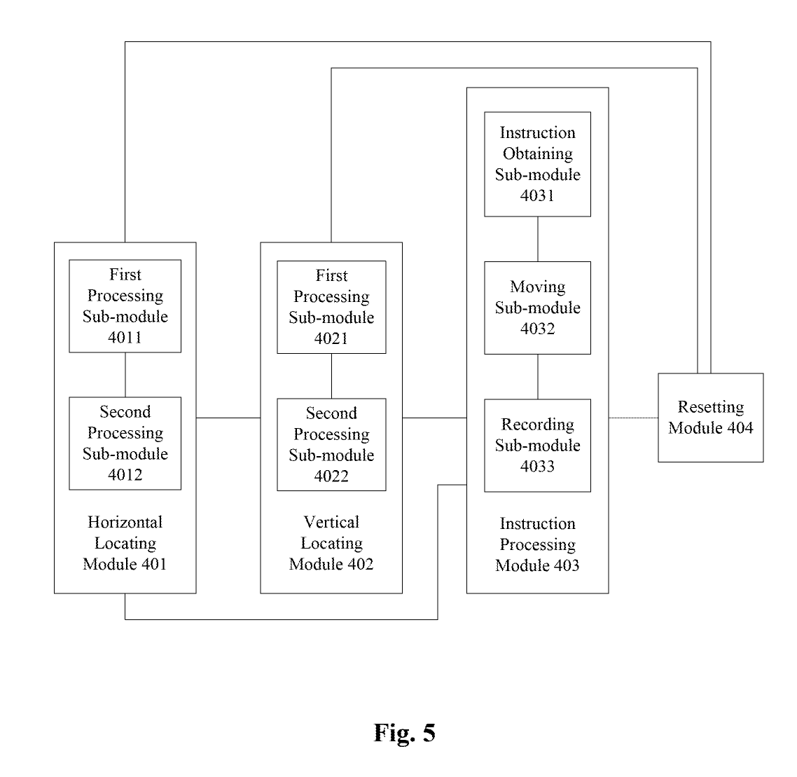

FIG. 5 is a block diagram of another apparatus for controlling a positioning of a camera device according to an exemplary embodiment.

As shown in FIG. 5, the apparatus for controlling the positioning of the camera device includes a horizontal locating module 401, a vertical locating module 402, an instruction processing module 403 and a resetting module 404.

Concerning the function of the horizontal locating module 401 and the vertical locating module 402, reference may be made to the description of FIG. 4.

The instruction processing module 403 is configured to move the camera device according to a movement instruction obtained, and to record a coordinate position where the camera device is moved to in the horizontal direction and the vertical direction after reaching the horizontal center position and the vertical center position.

The resetting module 404 is configured to control the camera device to first move to the horizontal center position and the vertical center position and to then move to the coordinate position recorded by the instruction processing module 403, after detecting that the camera device is toggled, restarted, or a set time period is reached.

The horizontal locating module 401 includes a first processing sub-module 4011 and a second processing sub-module 4012.

The first processing sub-module 4011 is configured to control the motor connected with the camera device to move in one of a horizontal-left direction and a horizontal-right direction, to record a rotation number of the motor when the motor is moved to a limit position in the one of the horizontal-left direction and the horizontal-right direction, to move the motor in the other of the horizontal-left direction and the horizontal-right direction, and to record an accumulative number of rotation turns of the motor between the two limit positions in the horizontal direction when the motor is moved to a limit position in the other of the horizontal-left direction and the horizontal-right direction.

The second processing sub-module 4012 is configured to move the motor in the one of the horizontal-left direction and the horizontal-right direction again by half of the accumulative number of rotation turns of the motor, so as to move the camera device to the horizontal center position.

The vertical locating module 402 includes a first processing sub-module 4021 and a second processing sub-module 4022.

The first processing sub-module 4021 is configured to control the motor connected with the camera device to move in one of a vertical-up direction and a vertical-down direction, to record a rotation number of the motor when the motor is moved to the limit position in the one of the vertical-up direction and the vertical-down direction, to move the motor in the other of the vertical-up direction and the vertical-down direction, and to record an accumulative number of rotation turns of the motor between the two limit positions in the vertical direction when the motor is moved to the limit position in the other of the vertical-up direction and the vertical-down direction.

The second processing sub-module 4022 is configured to move the motor in the one of the vertical-up direction and the vertical-down direction again by half of the accumulative rotation turns of the motor, so as to move the camera device to the vertical center position.

The instruction processing module 403 includes an instruction obtaining sub-module 4031, a moving sub-module 4032 and a recording sub-module 4033.

The instruction obtaining sub-module 4031 is configured to obtain a movement instruction from a mobile terminal or a remote controller. The movement instruction includes a target position to be moved to. The instruction obtaining sub-module 4031 obtains a movement instruction transmitted from the mobile terminal or the remote controller via WiFi, Bluetooth, or infrared connection.

The moving sub-module 4032 is configured to move the camera device to the target position from the horizontal center position and the vertical center position according to the target position obtained by the instruction obtaining sub-module 4031.

The recording sub-module 4033 is configured to record the coordinate position where the camera device is moved to by the moving sub-module 4032 in the horizontal direction and the vertical direction by recording a rotation number and a rotation direction of the motor in each of the horizontal direction and the vertical direction.

In the present embodiment, after the motor controls the camera device to reach the horizontal center position and the vertical center position, the camera device can be moved to the target position according to the movement instruction obtained, and the coordinate position where the camera device is moved to in the horizontal direction and the vertical direction is recorded. After it is detected that the camera device is toggled or restarted or the preset time period is reached, it is determined that an automatic reset process is triggered, such that the camera device is controlled to first move to the horizontal center position and the vertical center position and to then move to the recorded coordinate position where the camera device has been moved to in the horizontal direction and the vertical direction, thus realizing accurate positioning of the camera device in use.

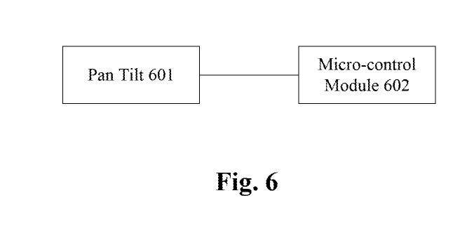

FIG. 6 is a block diagram of a camera device according to an exemplary embodiment.

As shown in FIG. 6, the camera device includes a pan tilt 601 and a micro-control module 602.

The pan tilt 601 is provided with a motor for driving the camera device to move.

The micro-control module 602 is configured to control the motor to move in a horizontal direction, to determine a horizontal center position according to a movement of the motor between two limit positions in the horizontal direction, and to move the camera device to the horizontal center position; and to control the motor to move in a vertical direction, to determine a vertical center position according to a movement of the motor between two limit positions in the vertical direction, and to move the camera device to the vertical center position.

Concerning the micro-control module 602, reference can be made to the description of FIG. 5. The micro-control module 602 includes a horizontal locating module, a vertical locating module, an instruction processing module and a resetting module (not shown in FIG. 6).

The horizontal locating module is configured to control the motor to move in the horizontal direction, to determine the horizontal center position according to the movement of the motor between the two limit positions in the horizontal direction, and to move the camera device to the horizontal center position.

The vertical locating module is configured to control the motor to move in the vertical direction, to determine the vertical center position according to the movement of the motor between the two limit positions in the vertical direction, and to move the camera device to the vertical center position.

The instruction processing module is configured to move the camera device according to a movement instruction obtained, and to record a coordinate position where the camera device is moved to in the horizontal direction and the vertical direction after reaching the horizontal center position and the vertical center position.

The resetting module is configured to control the camera device to first move to the horizontal center position and the vertical center position and to then move to the coordinate position recorded by the instruction processing module, after detecting that the camera device is toggled, restarted, or a set time period is reached.

In the present embodiment, by controlling the motor connected with the camera device to move in the horizontal direction and the vertical direction respectively, the horizontal center position can be determined according to the movement of the motor between the two limit positions in the horizontal direction and the vertical center position may be determined according to the movement of the motor between the two limit positions in the vertical direction, and finally the camera device can be moved to the horizontal center position and the vertical center position. In this manner, it is possible to control the camera device to be accurately positioned to a center position and thus to ensure the accuracy of the monitoring of the camera device.

Concerning the implementation of the function and action of individual unit in the devices in the above embodiments, reference is made to the implementation of corresponding steps of the above methods, which will not be elaborated herein.

Since the device embodiments substantially correspond to the method embodiments, reference is made to the description of the method embodiments as to details not disclosed in the device embodiments. The above-described device embodiments are merely for the purpose of illustration. Those units described as separated components may be or may not be physically separated; those units described as a display component may be or may not be a physical unit, i.e., either located at one place or distributed onto a plurality of network units. The object of the present disclosure can be achieved by part or all of modules in accordance with practical requirements. It would be appreciated and executable by those skilled in the art without creative labor.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of submodules.

Correspondingly, the present disclosure further provides a terminal.

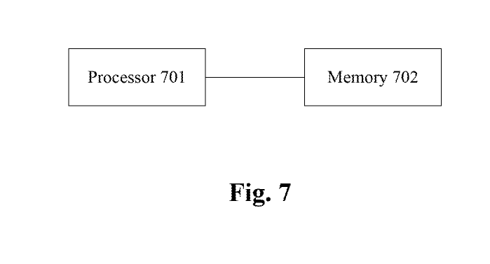

FIG. 7 is a block diagram of a terminal device according to an exemplary embodiment.

As shown in FIG. 7, the terminal device includes a processor 701 and a memory 702 for storing instructions executable by the processor.

The processor 701 is configured to: control a motor connected with the camera device to move in a horizontal direction, determine a horizontal center position according to a movement of the motor between two limit positions in the horizontal direction, and move the camera device to the horizontal center position; and control the motor connected with the camera device to move in a vertical direction, determine a vertical center position according to a movement of the motor between two limit positions in the vertical direction, and move the camera device to the vertical center position.

It should be noted that, concerning other programs stored in the memory 702, reference is made to the description of the above methods, which is not elaborated herein. The processor 701 is further configured to execute other programs stored in the memory 702.

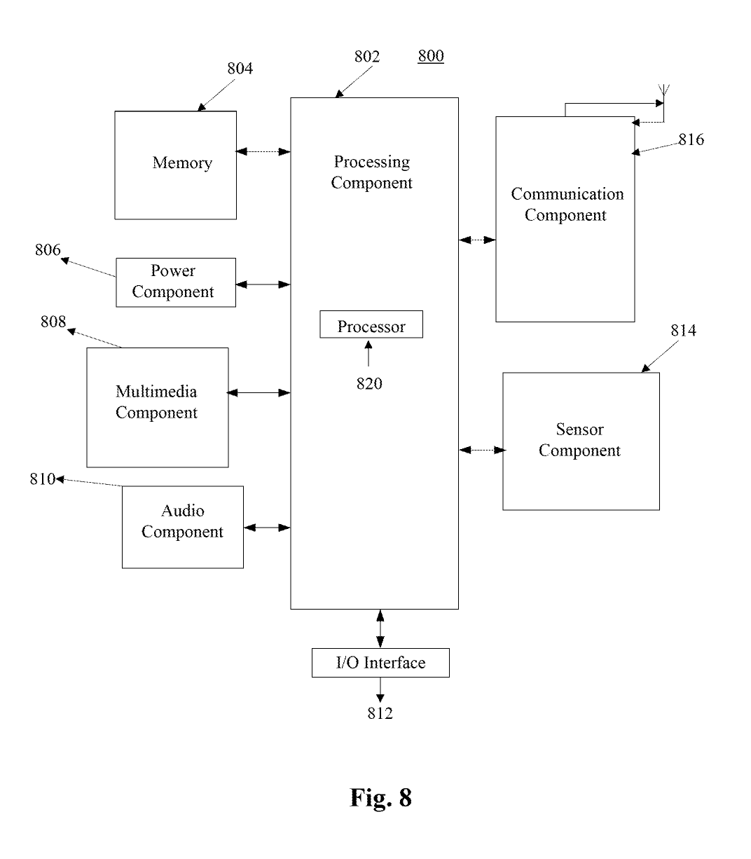

FIG. 8 is a block diagram of a device according to an exemplary embodiment.

For example, the device 800 can be a mobile phone, a computer, a digital broadcast terminal, a messaging device, a gaming console, a tablet, a medical device, exercise equipment, a personal digital assistant, and the like.

Referring to FIG. 8, the device 800 can include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the device 800, such as the operations associated with display, telephone calls, data communications, camera operations, and recording operations. The processing component 802 can include one or more processors 820 to execute instructions to perform all or part of the steps in the above described methods. Moreover, the processing component 802 can include one or more modules which facilitate the interaction between the processing component 802 and other components. For instance, the processing component 802 can include a multimedia module to facilitate the interaction between the multimedia component 808 and the processing component 802.

The memory 804 is configured to store various types of data to support the operation of the device 800. Examples of such data include instructions for any applications or methods operated on the device 800, contact data, phonebook data, messages, pictures, video, etc. The memory 804 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the device 800. The power component 806 can include a power management system, one or more power sources, and any other components associated with the generation, management, and distribution of power in the device 800.

The multimedia component 808 includes a screen providing an output interface between the device 800 and the user. In some embodiments, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 808 includes a front camera and/or a rear camera. The front camera and/or the rear camera can receive an external multimedia datum while the device 800 is in an operation mode, such as a photographing mode or a video mode. Each of the front camera and the rear camera can be a fixed optical lens system or have focus and optical zoom capability.

The audio component 810 is configured to output and/or input audio signals. For example, the audio component 810 includes a microphone (“MIC”) configured to receive an external audio signal when the device 800 is in an operation mode, such as a call mode, a recording mode, and a voice recognition mode. The received audio signal can be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons can include, but are not limited to, a home button, a volume button, a starting button, and a locking button.

The sensor component 814 includes one or more sensors to provide status assessments of various aspects of the device 800. For instance, the sensor component 814 can detect an open/closed status of the device 800, relative positioning of components, e.g., the display and the keypad, of the device 800, a change in position of the device 800 or a component of the device 800, a presence or absence of user contact with the device 800, an orientation or an acceleration/deceleration of the device 800, and a change in temperature of the device 800. The sensor component 814 can include a proximity sensor configured to detect the presence of nearby objects without any physical contact. The sensor component 814 can also include a light sensor, such as a CMOS or CCD image sensor, for use in imaging applications. In some embodiments, the sensor component 814 can also include an accelerometer sensor, a gyroscope sensor, a magnetic sensor, a pressure sensor, or a temperature sensor.

The communication component 816 is configured to facilitate communication, wired or wirelessly, between the device 800 and other devices. The device 800 can access a wireless network based on a communication standard, such as WiFi, 2G; or 3G; or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module can be implemented based on a radio frequency identification (RFID) technology, an infrared data association (IrDA) technology, an ultra-wideband (UWB) technology, a BLUETOOTH (BT) technology, and other technologies.

In exemplary embodiments, the device 800 can be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 804, executable by the processor 820 in the device 800, for performing the above-described methods. For example, the non-transitory computer-readable storage medium can be a ROM, a RAM, a CD-ROM, a magnetic tape, a floppy disc, an optical data storage device, and the like.

A non-transitory computer-readable storage medium is provided, having stored therein instructions that, when executed by a processor of a mobile terminal, cause the mobile terminal to perform a method for controlling a positioning of a camera device. The method includes: controlling a motor connected with the camera device to move in a horizontal direction, determining a horizontal center position according to a movement of the motor between two limit positions in the horizontal direction, and moving the camera device to the horizontal center position; and controlling the motor connected with the camera device to move in a vertical direction, determining a vertical center position according to a movement of the motor between two limit positions in the vertical direction, and moving the camera device to the vertical center position.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling a positioning of a camera device, comprising:
controlling a motor connected with the camera device to move in a horizontal direction, determining a horizontal center position according to a movement of the motor between two limit positions in the horizontal direction, and moving the camera device to the horizontal center position; and
controlling the motor connected with the camera device to move in a vertical direction, determining a vertical center position according to a movement of the motor between two limit positions in the vertical direction, and moving the camera device to the vertical center position.

2. The method of claim 1, further comprising:
moving the camera device according to a movement instruction obtained, and recording a coordinate position where the camera device is moved to in the horizontal direction and the vertical direction after reaching the horizontal center position and the vertical center position.

3. The method of claim 2, further comprising:
controlling the camera device to first move to the horizontal center position and the vertical center position and to then move to the coordinate position where the camera device has been moved to in the horizontal direction and the vertical direction, after detecting that the camera device is toggled, restarted, or a preset time period is reached.

4. The method of claim 1, wherein controlling a motor connected with the camera device to move in a horizontal direction, determining a horizontal center position according to a movement of the motor between two limit positions in the horizontal direction, and moving the camera device to the horizontal center position comprises:
controlling the motor connected with the camera device to move in one of a horizontal-left direction and a horizontal-right direction;
recording a rotation number of the motor when the motor is moved to the limit position in the one of the horizontal-left direction and the horizontal-right direction;
moving the motor in the other of the horizontal-left direction and the horizontal-right direction;
recording an accumulative number of rotation turns of the motor between the two limit positions in the horizontal direction, when the motor is moved to the limit position in the other of the horizontal-left direction and the horizontal-right direction; and
moving the motor in the one of the horizontal-left direction and the horizontal-right direction again by half of the accumulative number of rotation turns of the motor, so as to move the camera device to the horizontal center position.

5. The method of claim 1, wherein controlling the motor connected with the camera device to move in a vertical direction, determining a vertical center position according to a movement of the motor between two limit positions in the vertical direction, and moving the camera device to the vertical center position comprises:
controlling the motor connected with the camera device to move in one of a vertical-up direction and a vertical-down direction;
recording a rotation number of the motor when the motor is moved to the limit position in the one of the vertical-up direction and the vertical-down direction;
moving the motor in the other of the vertical-up direction and the vertical-down direction;
recording an accumulative number of rotation turns of the motor between the two limit positions in the vertical direction, when the motor is moved to the limit position in the other of the vertical-up direction and the vertical-down direction; and
moving the motor in the one of the vertical-up direction and the vertical-down direction again by half of the accumulative number of rotation turns of the motor, so as to move the camera device to the vertical center position.

6. The method of claim 2, wherein moving the camera device according to a movement instruction obtained, and recording a coordinate position where the camera device is moved to in the horizontal direction and the vertical direction after reaching the horizontal center position and the vertical center position comprises:
obtaining a movement instruction from a mobile terminal or a remote controller, in which the movement instruction comprises a target position to be moved to;
moving the camera device to the target position from the horizontal center position and the vertical center position according to the target position;
recording the coordinate position where the camera device is moved to in the horizontal direction and the vertical direction by recording a rotation number and a rotation direction of the motor in each of the horizontal direction and the vertical direction.

7. The method of claim 6, wherein obtaining a movement instruction from a mobile terminal or a remote controller comprises:
obtaining a movement instruction transmitted from the mobile terminal or the remote controller via WiFi, Bluetooth, or infrared connection.

8. An apparatus for controlling a positioning of a camera device, comprising:
a processor; and
a memory for storing instructions executable by the processor,
wherein the processor is configured to, when executing the instructions stored in the memory:
control a motor connected with the camera device to move in a horizontal direction, determine a horizontal center position according to a movement of the motor between two limit positions in the horizontal direction, and move the camera device to the horizontal center position; and
control the motor connected with the camera device to move in a vertical direction, determine a vertical center position according to a movement of the motor between two limit positions in the vertical direction, and move the camera device to the vertical center position.

9. The apparatus of claim 8, wherein the processor is further configured to:
move the camera device according to a movement instruction obtained, and record a coordinate position where the camera device is moved to in the horizontal direction and the vertical direction after reaching the horizontal center position and the vertical center position.

10. The apparatus of claim 9, wherein the processor is further configured to:
control the camera device to first move to the horizontal center position and the vertical center position and to then move to the coordinate position recorded, after detecting that the camera device is toggled, restarted, or a preset time period is reached.

11. The apparatus of claim 8, wherein the processor is configured to:
control the motor connected with the camera device to move in one of a horizontal-left direction and a horizontal-right direction, record a rotation number of the motor when the motor is moved to the limit position in the one of the horizontal-left direction and the horizontal-right direction, move the motor in the other of the horizontal-left direction and the horizontal-right direction, and record an accumulative number of rotation turns of the motor between the two limit positions in the horizontal direction when the motor is moved to the limit position in the other of the horizontal-left direction and the horizontal-right direction;
move the motor in the one of the horizontal-left direction and the horizontal-right direction again by half of the accumulative number of rotation turns of the motor, so as to move the camera device to the horizontal center position.

12. The apparatus of claim 8, wherein the processor is configured to:
control the motor connected with the camera device to move in one of a vertical-up direction and a vertical-down direction, record a rotation number of the motor when the motor is moved to the limit position in the one of the vertical-up direction and the vertical-down direction, move the motor in the other of the vertical-up direction and the vertical-down direction, and record an accumulative number of rotation turns of the motor between the two limit positions in the vertical direction when the motor is moved to the limit position in the other of the vertical-up direction and the vertical-down direction;
move the motor in the one of the vertical-up direction and the vertical-down direction again by half of the accumulative number of rotation turns of the motor, so as to move the camera device to the vertical center position.

13. The apparatus of claim 8, wherein the processor is configured to:
obtain a movement instruction from a mobile terminal or a remote controller, in which the movement instruction comprises a target position to be moved to;
move the camera device to the target position from the horizontal center position and the vertical center position according to the target position;
record the coordinate position where the camera device is moved to in the horizontal direction and the vertical direction by recording a rotation number and a rotation direction of the motor in each of the horizontal direction and the vertical direction.

14. The apparatus of claim 13, wherein the processor is configured to obtain the movement instruction transmitted from the mobile terminal or the remote controller via WiFi, Bluetooth, or infrared connection.

15. A camera device, comprising:
a pan tilt provided with a motor for driving the camera device to move;
a micro-processor, configured to:
control the motor to move in a horizontal direction, to determine a horizontal center position according to a movement of the motor between two limit positions in the horizontal direction, and to move the camera device to the horizontal center position; and
control the motor to move in a vertical direction, to determine a vertical center position according to a movement of the motor between two limit positions in the vertical direction, and to move the camera device to the vertical center position.

16. The device of claim 15, wherein the micro-processor is further configured to:
move the camera device according to a movement instruction obtained, and to record a coordinate position where the camera device is moved to in the horizontal direction and the vertical direction after reaching the horizontal center position and the vertical center position.

17. The device of claim 16, wherein the micro-processor is further configured to:
control the camera device to first move to the horizontal center position and the vertical center position and to then move to the coordinate position recorded, after detecting that the camera device is toggled, restarted, or a preset time period is reached.

18. The device of claim 15, wherein the micro-processor is configured to:
control the motor connected with the camera device to move in one of a horizontal-left direction and a horizontal-right direction;
record a rotation number of the motor when the motor is moved to the limit position in the one of the horizontal-left direction and the horizontal-right direction;
move the motor in the other of the horizontal-left direction and the horizontal-right direction;
record an accumulative number of rotation turns of the motor between the two limit positions in the horizontal direction, when the motor is moved to the limit position in the other of the horizontal-left direction and the horizontal-right direction;
move the motor in the one of the horizontal-left direction and the horizontal-right direction again by half of the accumulative number of rotation turns of the motor, so as to move the camera device to the horizontal center position.

19. The device of claim 15, wherein the micro-processor is configured to:
control the motor connected with the camera device to move in one of a vertical-up direction and a vertical-down direction;
record a rotation number of the motor when the motor is moved to the limit position in the one of the vertical-up direction and the vertical-down direction;
move the motor in the other of the vertical-up direction and the vertical-down direction;
record an accumulative number of rotation turns of the motor between the two limit positions in the vertical direction, when the motor is moved to the limit position in the other of the vertical-up direction and the vertical-down direction; and
move the motor in the one of the vertical-up direction and the vertical-down direction again by half of the accumulative number of rotation turns of the motor, so as to move the camera device to the vertical center position.

20. The device of claim 16, wherein the micro-processor is configured to:
obtain a movement instruction from a mobile terminal or a remote controller, in which the movement instruction comprises a target position to be moved to;
move the camera device to the target position from the horizontal center position and the vertical center position according to the target position;
record the coordinate position where the camera device is moved to in the horizontal direction and the vertical direction by recording a rotation number and a rotation direction of the motor in each of the horizontal direction and the vertical direction.
